(19) United States
(12) Patent Application Publication
(10) Pub. No.: US 2004/0122856 A1
(43) Pub. Date: Jun. 24, 2004

(54) Apparatus and method for market-based document content and layout selection

(76) Inventor: Scott H. Clearwater, Portola Valley, CA (US)

Correspondence Address: HEWLETT-PACKARD COMPANY, Intellectual Property Administration, P.O. Box 272400, Fort Collins, CO, 80527-2400, US

(21) Appl. No.: 10/326,057

(22) Filed: Dec. 23, 2002

(51) Int. Cl. G06F 7/00

(52) U.S. Cl. 707/104.1

(57) ABSTRACT

A method and corresponding apparatus for market-based document content and layout selection use an automated auction or bartering system, i.e., an automated content and layout coordination system, to automatically coordinate content and layout selection for document presentation. The system takes simple criteria from a user and automatically constructs virtual documents from a much larger underlying database of content and layout. By trading among the virtual documents, the automated content and layout coordination system affords a flexible and scalable method for coordinating the selection of high-value content and layout and generating a high value document.

### CROSS-REFERENCE TO RELATED PATENT APPLICATIONS

This application is related to commonly assigned U.S. patent application Ser. No. 10/______ (Attorney Docket No. 100202497-1), entitled “APPARATUS AND METHOD FOR MARKET-BASED DOCUMENT CONTENT SELECTION” to Scott H. CLEARWATER; U.S. patent application Ser. No. 10/______ (Attorney Docket No. 10019008-1), entitled “APPARATUS AND METHOD FOR DOCUMENT CONTENT TRADING” to Scott H. CLEARWATER, et al.; U.S. patent application Ser. No. 10/______ (Attorney Docket No. 10018740-1), entitled “APPARATUS AND METHOD FOR CONTENT RISK MANAGEMENT” to Scott H. CLEARWATER; U.S. patent application Ser. No. 10/______ (Attorney Docket No. 100110399-1), entitled “APPARATUS AND METHOD FOR MARKET-BASED GRAPHICAL GROUPING” to Henry W. SANG, Jr., et al., and U.S. patent application Ser. No. 10/______ (Attorney Docket No. 10019320-1), entitled “APPARATUS AND METHOD FOR MARKET-BASED DOCUMENT LAYOUT SELECTION” to Henry W. SANG, Jr., et al., all of which are concurrently herewith being filed under separate covers, the subject matters of which are herein incorporated by reference.

### TECHNICAL FIELD

The technical field relates to document selection systems, and, in particular, to market-based document content and layout selection systems.

### BACKGROUND

Content selection and layout presentation are important to document composition. In constructing a document, such as catalog or advertisement, users typically select document elements from a large corpus of possible items, or a number of possible combinations of various items. Without the time or ability to articulate what is intended, users usually need help in selecting such document elements. In addition, most users do not have the time or skills to organize the page elements in an appealing fashion. Therefore, being able to automatically include document elements on pages and laying out the document elements in an appealing style are important in creating a high-value document.

Some current solutions focus on complicated rule sets that are difficult to maintain and understand. For example, since many circumstances cannot be known in advance, a rule-based approach may easily cause error when unanticipated situations occur. Furthermore, while contingencies can in principle be codified, the resulting system is not easily maintainable because the rules can interact with each other in complicated and unforeseen ways. Other solutions mostly focused on either retrieving content or layout without coordination between the content selection and the layout selection, which lead to lower document value.

### SUMMARY

A method for coordinating market-based document content and layout selection includes using a starting content selection containing a plurality of document contents, generating a first content selection containing preferred document contents with respect to user preferences. The first content selection improves a value of the document. The method further includes using the first content selection, generating a first layout selection with preferred document layouts with respect to the user preferences. The first layout selection further improves the value of the document. The method further includes using the first layout selection, regenerating a second content selection that further improves the value of the document, and repeating the generating steps until a stopping criterion is met.

A corresponding apparatus for market-based document content and layout selection includes a content broker that uses a starting content selection to generate a first content selection that contains preferred document contents based on user preferences. The apparatus further includes a layout broker that uses the first content selection to generate a first layout selection that contains preferred document layouts based on the user preferences. The apparatus further includes a coordinator that coordinates the first content selection and the first layout selection and repeats the generating steps until a stopping criteria is met.

### DESCRIPTION OF THE DRAWINGS

The preferred embodiments of the method and apparatus for market-based document content and layout selection will be described in detail with reference to the following figures, in which like numerals refer to like elements, and wherein:

FIG. 1 illustrates an exemplary document with pages that include various objects;

FIG. 2 illustrates an exemplary automated content and layout coordination system, according to one embodiment of the present invention;

FIG. 3A is a flow chart illustrating an exemplary operation of a coordinator of the automated content and layout coordination system of FIG. 2, according to another embodiment of the present invention;

FIG. 3B illustrates an exemplary evaluation processes of FIG. 3A, according to another embodiment of the present invention; and

FIG. 4 illustrates exemplary hardware components that may be used in connection with the method for market-based document content and layout selection, according to another embodiment of the present invention.

### DETAILED DESCRIPTION

A method and corresponding apparatus for market-based document content and layout selection use an automated auction or bartering system, i.e., an automated content and layout coordination system, to automatically coordinate content and layout selection for document presentation. The system takes simple criteria from a user and automatically constructs virtual documents from a much larger underlying database of content and layout. By trading among the virtual documents, the automated content and layout coordination system affords a flexible and scalable method for coordinating the selection of high-value content and layout and generating a high value document.

With the market-based document layout selection approach, document elements compete with each other in a “market” where a page tries to “buy” a content item or a layout that the page deems valuable. The value of a particular page is based on a number of factors relating to user preferences, such as price or style. The advantage of a market-based approach is that the market-based approach does not require a fixed set of rules that must be able to handle all possible contingencies.

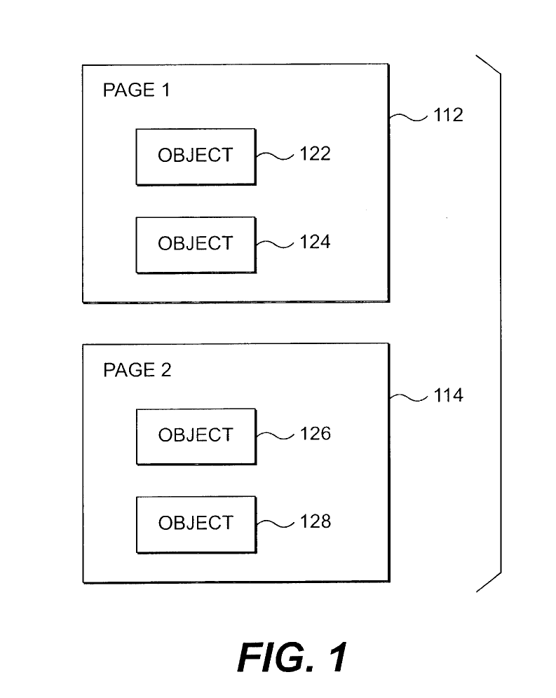

In document construction, different objects are placed on pages. An object refers to any item that can be individually selected and manipulated, and may include shapes and pictures that appear on a display screen. An object may include both data and programmed procedures that allow manipulation of that data. Examples of the objects include images, tables, columns of information, boxes of data, graphs of data, audio snippets for electronic versions of assignments, active pages such as an applet for electronic version, animations or the like. The images may be drawings or photographs in color or black and white. An active page is a page that changes layout when a user modifies an object on the page. FIG. 1 illustrates an exemplary document with Page 1 112, Page 2 114. Page 1 112 includes objects 122, 124, whereas Page 2 114 includes objects 126, 128.

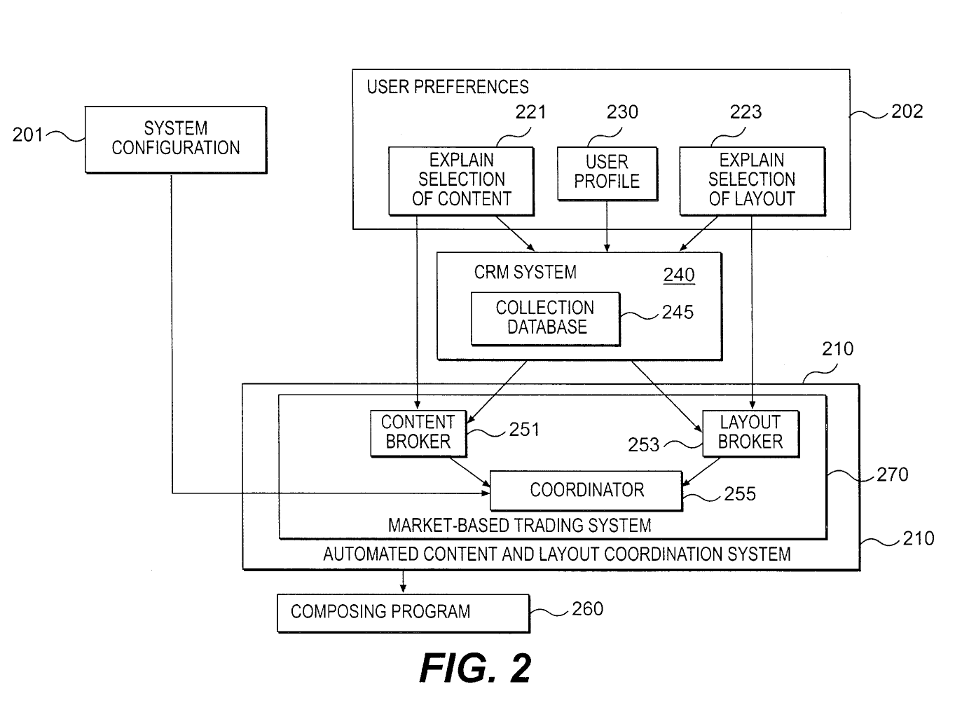

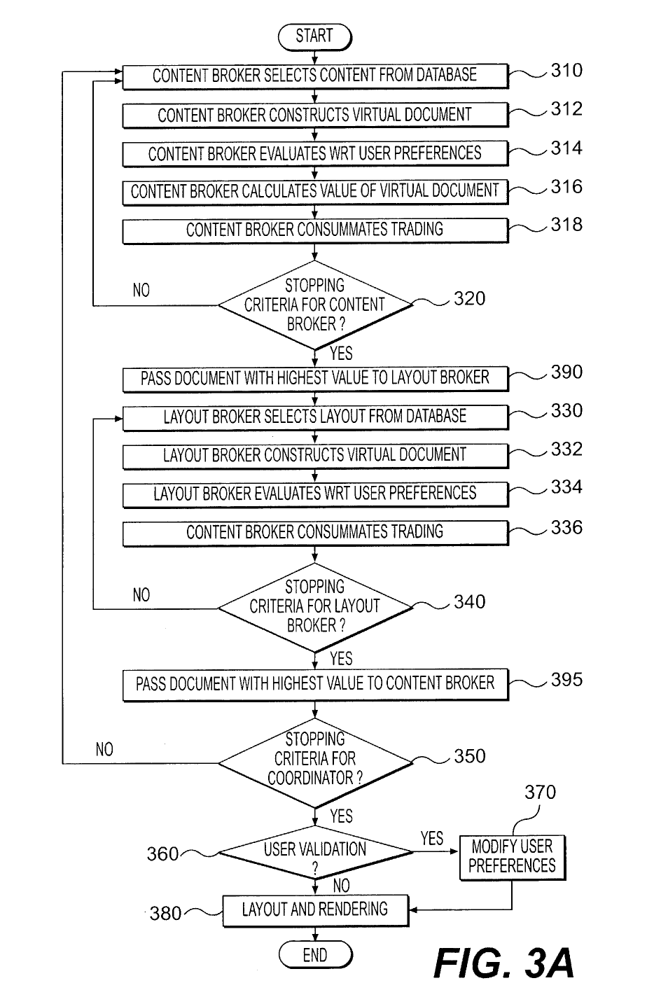

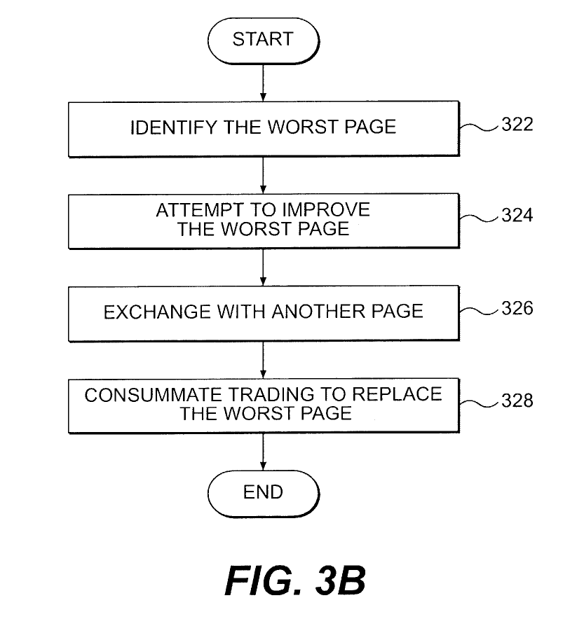

FIG. 2 illustrates an exemplary automated content and layout coordination system 210 that utilizes a market-based trading system 270 to automatically select content and layout for document presentation through, for example, an auction process. The market-based trading system 270 may include a content broker 251, a layout broker 252, and a coordinator 255. The content broker 251 may use a content selection algorithm to supervise and coordinate the type of content to be placed on various pages of a document. The layout broker 252 may use a layout selection algorithm to supervise and coordinate the type of layout. The coordinator 255 may coordinate the interaction between the content selection and the layout selection. (The algorithms are described in detail with respect to FIG. 3). The coordinator 255 may have inputs from system configuration 201, the content broker 251, and the layout broker 252. The system configuration input 201 serves to set the configuration parameters for coordinating the content selection and layout selection algorithms. Table 1 illustrates exemplary parameters of the system configuration input 201.

TABLE 1

| | IHPS_content_layout_coordination_configuration | | |
|---|---|---|---|
| Port | Msg | | |
| Operations | Type | Msg Data | Msg Data Type |
| get_configuration_requirements | Input | configuration_type | string |
| | Output | attribute_value_pairs | attribute_value_pairs |
| get_all_configurations | Input | administrator_profile | administrator_profile |
| | Output | configuration_descriptions | configuration_descriptions |
| get_a_configuration | Input | configuration_id | string |
| | Output | configuration_description | configuration_description |
| New_configuration | Input | attribute_value_pairs | attribute_value_pairs |
| | | configuration_type | string |
| | Output | configuration_id | string |
| modify_configuration | Input | configuration_id | string |
| | | attribute_value_pairs | attribute_value_pairs |
| | Output | configuration_id | string |
| set_configuration | Input | authorization | string |
| | | attribute_value_pairs | attribute_value_pairs |
| | Output | configuration_id | ascii_file |

Referring to FIG. 2, the content broker 251 and the layout broker 253 automatically selects content and layout based on user preferences 202. The initialization of the content broker 251 and the layout broker 253 may be random. In other words, the initial contents and layouts may be chosen randomly. The user preferences 202 may include an explicit user selection 221, 223 or a user profile 230 that is connected to a customer resource management (CRM) system 240. One skilled in the art will appreciate that the CRM system 240 may be a knowledge management system, document management system, database management system, or other types of files management systems. The user profile 230 may be compared to the CRM system 240 to select contents or layouts from a collection database 245. Next, the content broker 251 and the layout broker 253 may construct virtual documents based on the selected contents and layouts, respectfully. With the CRM system 240, the contents and layouts preferred by similar customers, typically saved in the collection database 245, may be used to construct the virtual documents. The virtual documents may then be scored by the content broker 251 and the layout broker 253 based on the documents' value with respect to the user preferences 202. For example, a user may prefer images to be blue. Images in virtual documents may be graded on how much blue the images contain. The better the system 210 matches the characteristics specified by the user, the higher the value of the virtual document is with respect to the user preferences 202. A user may also select particular types of fonts or particular article sizes as preferences. Thereafter, the content broker 251 and the layout broker 253 may consummate one or more trades to improve the virtual documents' value. The content broker 251 and the layout broker 253 typically do not contact each other and only allow trades that add value to the documents. The coordinator 255 may supervise the operation of the content broker 251 and the layout broker 253 to produce a final document with increased overall value.

The content broker 251 may be given criteria such as number of content elements per page, while the layout broker 253 may be given criteria such as dimensions and image meta data for each content element selected by the content broker 253. The coordinator 255 may then pass the selection of the content broker 251 to the layout broker 253 for layout improvement. The layout broker 253 may then generate virtual documents, score the documents, and consummate one or more trades to improve the value of the virtual documents. Thereafter, the coordinator 255 may pass the best document with enhanced layout back to the content broker 251 for content improvement with respect to the new layout. Similarly, the content broker 251 may generate virtual documents, score the documents, and consummate one or more trades to improve the value of the virtual documents. The best document with preferred content elements may then be passed back to the coordinator 255. The coordinator 255 may coordinate the trading until the coordinator 255 detects that the value of the best document has not changed within a pre-specified number of iterations. The coordinator 255 may then send the best document to a composing program 260 for display or printing. Alternatively, the coordinator 255 may stop the trading after a certain number of iterations as set by a system parameter.

Any document may have a spread in the value of the individual contents. Consequently, higher value contents may be traded off to generate a less “risky” document with a higher overall value. A less risky document is a document with a smaller chance of containing poor or undesirable contents. Less risky documents typically have higher value because the documents are less likely to be ignored due to the presence of a few low value content elements.

FIG. 3A is a flow chart illustrating an exemplary operation of the coordinator 255. As noted above, the content broker 251 supervises and coordinates content selection. First, the content broker 251 selects a content from a database that includes collections or other documents (block 310) and constructs a virtual document using the newly selected content (block 312). Next, the content broker 251 evaluates the newly selected content (block 314) and calculates a value of the virtual document with respect to the user preferences 202 (block 316). The value of the virtual document may be calculated by comparing the attributes of the content (such as size, predominant color, latest version, or author's name) with the preferences defined by the user. The comparison may be explicit comparisons or other types of comparisons. If the value of the virtual document is increased with respect to the user preferences 202, the content broker 251 consummates a trade to replace an old content with the newly selected content (block 318).

The process of “select, construct, evaluate, calculate, and trade” is repeated until a stopping criterion for content broker is met (block 320). The stopping criterion may be met when the content “perfectly” matches the user preferences 202, the content broker 251 cannot further improve the value of the virtual documents, or a previously set number of cycles have been completed. The virtual document with the highest value is passed to the layout broker 253 by the coordinator 255 (block 390).

As noted above, the layout broker 253 supervises and coordinates layout selection. After receiving the document with preferred content from the coordinator 255, the layout broker 253 selects a layout from a database that includes collections or other documents (block 330) and constructs another virtual document using the newly selected layout (block 332). Next, the layout broker 253 evaluates the newly selected layout (block 334) and calculates a value of the virtual document with respect to the user preferences 202 (block 336) by comparing characteristics (such as size, positioning, density, or directional orientation) of the layout with the preferences defined by the user. If the value of the virtual document is increased with respect to the user preferences 202, the layout broker 253 consummates a trade to replace an old layout with the newly selected layout (block 338).

The process of “select, construct, evaluate, calculate, and trade” is repeated until a similar stopping criterion for layout broker is met (block 340), and the virtual document with the highest value is passed to the content broker 251 by the coordinator 255 (block 395).

The coordinator 255 coordinates the trading by the content broker 251 and the layout broker 253 until a stopping criterion for coordinator is met (block 350). The stopping criterion for coordinator may be met when the system 210 cannot further improve the value of virtual documents, or a previously set number of cycles have been completed (block 350).

Once the stopping criteria for coordinator have been met (block 350), the user may choose to validate the results (block 360), and modify preferences (block 370) for future trading. The user validation phase need not be automated, but may involve viewing the printed document and adding updated preferences. Alternatively, the user may modify preferences (block 370) through a graphical user interface (GUI) while the content broker 251 and the layout broker 253 continue with another round of trading. Finally, the virtual document with the highest value is selected to be sent for document layout and rendering (block 380).

FIG. 3B illustrates an exemplary evaluation processes of blocks 314 and 334. Exemplary content selection and layout selection algorithms may utilize an “Extremal Optimization” technique, which in general replaces extremely undesirable elements of a single sub-optimal solution with new, random elements. In the page content and layout selection context, the exemplary algorithms identify the “worst” page (with respect to the user preferences 202) from the virtual documents (block 322) and attempt to improve the worst page (block 324). The improvements may be accomplished through exchanging content or layout with another page or with the collection database 245. The content broker 251 or layout broker 253 then consummates a trade to replace the worst page with another page if both pages are improved as a result of the exchange (trade). If the trade is made with the collection database 245, only the worst page needs to improve its value before a trade is consummated.

Table 3 shows a sample input file for the coordinator 255. The coordinator 255 may modify the configuration files for a particular selection trade in order to improve the value of the document. The output of the coordinator 255 is the combination of output by the content broker 251 and the layout broker 253 that is sufficient for the composing program 260 to construct the pages.

TABLE 3

| Input Name | Description | Example |
|---|---|---|
| MaxCycles | Maximum number of coordinated iterations | 1000 |
| | between Content Broker and Layout Broker-a | |
| | stopping criteria | |
| ChangeCycles | If the change in value of the best document had not | 100 |
| | changed in the last ChangeCycles, then the | |
| | coordination iteration is stopped. | |
| ContentPreferences | Preferences for the content as used by the Content | Content.inp |
| | Broker, no matter where it came from (user | file |
| | selection, user choices, CRM). | |
| LayoutPreferences | Preferences for the layout as used by the Layout | Layout.inp |
| | Broker, no matter where it came from (user | file |
| | selection, user choices, CRM). | |

Table 4 shows two examples illustrating how the coordinator 255 manages sub-optimal results for either the content broker 251 or layout broker 253.

TABLE 4

| Situation | Coordinator Solution |
|---|---|
| According to Layout | Coordinator sends message to Content |
| Broker, content violates | Broker to perform another round of trading, |
| some criteria for nice | with the additional proviso that colors are to |
| layouts, such as poor mix | be selected for/against on certain pages. |
| of colors on the page. | |
| According to Content | Coordinator sends message to Layout |
| Broker, the current | Broker to perform another round of trading |
| layout has too little material | with the additional proviso that more slots |
| on it to be of | for content be put on the page. |
| much overall value. | |

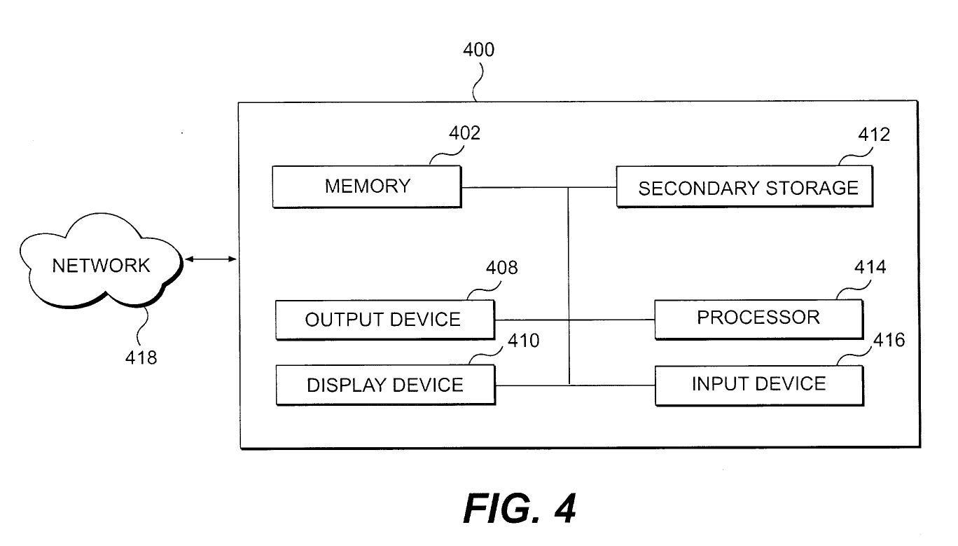

FIG. 4 illustrates exemplary hardware components of a computer 400 that may be used in connection with the method for market-based document layout selection. The computer 400 includes a connection with a network 418 such as the Internet or other type of computer or telephone network. The computer 400 typically includes a memory 402, a secondary storage device 412, a processor 414, an input device 416, a display device 410, and an output device 408.

The memory 402 may include random access memory (RAM) or similar types of memory. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), microphone or the like. The display device 410 may include any type of device for presenting visual image, such as, for example, a computer monitor, flat-screen display, display panel or the like. The output device 408 may include any type of device for presenting data in hard copy format, such as a printer or printing device, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the method for market-based document content and layout selection are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 400 to perform a particular method.

While the method and apparatus for market-based document content and layout selection have been described in connection with an exemplary embodiment, those skilled in the art will understand that many modifications in light of these teachings are possible, and this application is intended to cover any variations thereof.

What is claimed is:

1. A method for coordinating market-based document content and layout selection for a document, comprising:
using a starting content selection containing a plurality of document contents, generating a first content selection containing preferred document contents with respect to user preferences, wherein the first content selection improves a value of the document;
using the first content selection, generating a first layout selection with preferred document layouts with respect to the user preferences, wherein the first layout selection further improves the value of the document;
using the first layout selection, regenerating a second content selection, wherein the second content selection further improves the value of the document; and
repeating the generating steps until a stopping criterion is met.

2. The method of claim 1, wherein the generating the first content selection step comprises:
selecting a plurality of contents from one or more databases;
constructing a plurality of virtual documents using the plurality of selected contents;
evaluating the plurality of selected contents with respect to user preferences;
calculating values of the plurality of virtual documents based on the evaluation; and
consummating a trade from an old content to one of the plurality of selected contents, if the value of the corresponding virtual document increases.

3. The method of claim 2, wherein the evaluating step includes evaluating the plurality of selected contents with respect to an explicit selection.

4. The method of claim 2, wherein the evaluating step includes evaluating the plurality of selected contents with respect to a user profile.

5. The method of claim 1, wherein the generating the first layout selection step comprises:
selecting a plurality of layouts from one or more databases;
constructing a plurality of virtual documents using the plurality of selected layouts;
evaluating the plurality of selected layouts with respect to user preferences;
calculating values of the plurality of virtual documents based on the evaluation; and
consummating a trade from an old layout to one of the plurality of selected layouts, if the value of the corresponding virtual document increases.

6. The method of claim 5, wherein the evaluating step includes evaluating the plurality of selected layouts with respect to an explicit selection.

7. The method of claim 5, wherein the evaluating step includes evaluating the plurality of selected layouts with respect to a user profile.

8. The method of claim 1, further comprising validating the first content selection, the first layout selection, and the second content selection.

9. The method of claim 1, further comprising modifying the user preferences based on the first content selection, the first layout selection, and the second content selection.

10. The method of claim 1, wherein the stopping criteria is met after the value of the document cannot be improved.

11. The method of claim 1, wherein the stopping criteria is met after a set number of cycles are completed.

12. The method of claim 1, further comprising using a market-based trading system for coordinating the market-based document content and layout selection.

13. An apparatus for coordinating market-based document content and layout selection, comprising:
a content broker that uses a starting content selection to generate a first content selection, wherein the first content selection contains preferred document contents based on user preferences;
a layout broker that uses the first content selection to generate a first layout selection, wherein the first layout selection contains preferred document layouts based on the user preferences; and
a coordinator that coordinates the first content selection and the first layout selection and repeats the generating steps until a stopping criteria is met.

14. The apparatus of claim 13, wherein the content broker uses a market-based trading system to generate the first content selection.

15. The apparatus of claim 13, wherein the layout broker uses a market-based trading system to generate the first layout selection.

16. The apparatus of claim 13, wherein the stopping criteria is met after a set number of cycles are completed.

17. A computer readable medium providing instructions for coordinating market-based document content and layout selection, the instructions comprising:
using a starting content selection containing a plurality of document contents, generating a first content selection containing preferred document contents with respect to user preferences, wherein the first content selection improves a value of the document;
using the first content selection, generating a first layout selection with preferred document layouts with respect to the user preferences, wherein the first layout selection further improves the value of the document;
using the first layout selection, regenerating a second content selection, wherein the second content selection further improves the value of the document; and
repeating the generating steps until a stopping criterion is met.

18. The computer readable medium of claim 17, further comprising instructions for using a coordinator for coordinating the market-based document content and layout selection.

19. The computer readable medium of claim 17, further comprising instruction for validating the first content selection, the first layout selection, and the second content selection.

20. The computer readable medium of claim 17, further comprising instruction for modifying the user preferences based on the first content selection, the first layout selection, and the second content selection.

21. An apparatus for coordinating market-based document content and layout selection for a document, comprising:
means for generating a first content selection containing preferred document contents with respect to user preferences using a starting content selection containing a plurality of document contents, wherein the first content selection improves a value of the document;
means for generating a first layout selection with preferred document layouts with respect to the user preferences using the first content selection, wherein the first layout selection further improves the value of the document;
means for regenerating a second content selection using the first layout selection, wherein the second content selection further improves the value of the document; and
means for repeating the generating steps until a stopping criterion is met.

22. The apparatus of claim 21, wherein the means for generating the first content selection comprises:
means for selecting a plurality of contents from one or more databases;
means for constructing a plurality of virtual documents using the plurality of selected contents;
means for evaluating the plurality of selected contents with respect to user preferences;
means for calculating values of the plurality of virtual documents based on the evaluation; and
means for consummating a trade from an old content to one of the plurality of selected contents, if the value of the corresponding virtual document increases.

23. The apparatus of claim 21, wherein the means for generating the first layout selection comprises:
means for selecting a plurality of layouts from one or more databases;
means for constructing a plurality of virtual documents using the plurality of selected layouts;
means for evaluating the plurality of selected layouts with respect to user preferences;
means for calculating values of the plurality of virtual documents based on the evaluation; and
means for consummating a trade from an old layout to one of the plurality of selected layouts, if the value of the corresponding virtual document increases.
